(19) United States
(12) Patent Application Publication
(10) Pub. No.: US 2025/0094101 A1
(43) Pub. Date: Mar. 20, 2025

(54) INFORMATION PROCESSING APPARATUS, COMMUNICATION APPARATUS SELECTION METHOD, AND MEDIUM

(71) Applicant: CANON KABUSHIKI KAISHA, Tokyo (JP)

(72) Inventor: SHU IWATA, Kanagawa (JP)

(21) Appl. No.: 18/827,953

(22) Filed: Sep. 9, 2024

(30) Foreign Application Priority Data
Sep. 15, 2023 (JP) 2023-150283

(51) Int. Cl. G06F 3/12

(52) U.S. Cl. CPC G06F 3/1226; G06F 3/1204; G06F 3/1236; G06F 3/126; G06F 3/1292

(57) ABSTRACT

A control method for a computer including a predetermined application comprises: obtaining predetermined information for registering a printer from the printer; registering the printer to the predetermined application by associating the printer with information relating to an AP; selecting, as a transmission destination of a job, a printer from the registered apparatuses; and transmitting the job to the printer selected as the transmission destination of the job, wherein in a case where the computer is connecting with a predetermined AP at a predetermined timing for selecting the destination of the job, the printer associated with the information relating to the predetermined AP and registered to the predetermined application is automatically selected by the predetermined application program as the destination of the job on a basis of the computer being connecting with the predetermined AP at the predetermined timing.

### BACKGROUND OF THE INVENTION

### Field of the Invention

The present invention relates to an information processing apparatus, a communication apparatus selection method, and a medium.

### Description of the Related Art

A known technique automatically detects a printer or a scanner for printing and reading when the printer or scanner is caused to print and image or read a document using a portable terminal such as a carriable smartphone. Japanese Patent Laid-Open No. 2015-106305 describes a technique for selecting an appropriate printer or read by storing position information of a terminal of when the printer or scanner was caused to print or read and compare this with position information of the terminal of when the printer or scanner is newly caused to print or read.

However, to use position information, permission from the user with the recorded position information is required. With awareness revolving around privacy increasing of late, in some cases, accurate position information of a terminal may be unable to be obtained, and thus an appropriate printer may be unable to be selected.

### SUMMARY OF THE INVENTION

The present disclosure provides an information processing apparatus, a communication apparatus selection method, and a program for appropriately identifying a communication apparatus to execute a predetermined processing.

According to one aspect of the present disclosure, a control method for an information processing apparatus including a predetermined application program is provided. The control method comprises: obtaining predetermined information for registering a communication apparatus from the communication apparatus; registering the communication apparatus, which is a transmission source of the predetermined information, to the predetermined application program by associating the communication apparatus with information relating to an access point to which the information processing apparatus was connected when the predetermined information was obtained; selecting, as a transmission destination of a job, a communication apparatus from among a plurality of the communication apparatuses registered to the predetermined application program; and transmitting the job to the communication apparatus selected as the transmission destination of the job, wherein in a case where the information processing apparatus is connecting with a predetermined access point at a predetermined timing for selecting the transmission destination of the job, the communication apparatus associated with the information relating to the predetermined access point and registered to the predetermined application program is automatically selected by the predetermined application program as the transmission destination of the job on a basis of the information processing apparatus being connecting with the predetermined access point at the predetermined timing.

According to the present disclosure, a communication apparatus an information processing apparatus causes to execute a predetermined processing can be appropriately selected via an access point connected to the information processing apparatus.

Further features of the present invention will become apparent from the following description of exemplary embodiments with reference to the attached drawings.

### BRIEF DESCRIPTION OF THE DRAWINGS

FIG. 1 is a diagram illustrating the configuration of a printing system according to the present embodiment.

FIG. 2 is a diagram illustrating an application configuration of an information processing apparatus 101.

FIG. 3 is a diagram illustrating a communication apparatus list.

FIG. 4 is a diagram illustrating history information.

FIG. 5 is a diagram illustrating a start-up screen of an application.

FIG. 6 is a flowchart illustrating an example of processing executed upon application start-up.

FIG. 7A is a flowchart illustrating connection setting processing executed by the information processing apparatus.

FIG. 7B is a flowchart illustrating connection setting processing executed by the information processing apparatus.

FIG. 7C is a flowchart illustrating connection setting processing executed by the information processing apparatus.

FIG. 8 is a flowchart illustrating processing for updating a list of access points executed by the information processing apparatus.

FIG. 9 is an example of a password input screen.

FIG. 10 is a flowchart illustrating an example of processing executed when the information processing apparatus is not connected to an access point.

FIG. 11 is a diagram illustrating an example of a direct communication apparatus list.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The present embodiment will be described using an example in which a portable terminal, an example of an information processing apparatus, puts a printer, an example of a communication apparatus, in a state in which it can execute printing. Specifically, as preparation for the portable terminal to cause the printer to execute processing such as printing, registration processing of the printer in a communication apparatus list and history information held by the portable terminal is executed. Also, using the information of an access point which the terminal is connected to, an appropriate image processing apparatus is selected from the communication apparatus list. Examples of preferred embodiments of the present invention will be described below with reference to the drawings. However, it should be understood that the scope of the present invention includes any appropriate modifications and enhancements to the embodiments described below based on the ordinary knowledge of one skilled in the art, without departing from the spirit of the present invention.

### First Embodiment

An information processing apparatus and a communication apparatus included in a communication system according to the present embodiment will now be described. In the present embodiment, a smartphone is used as an example of the information processing apparatus, but no such limitation is intended. It is sufficient that the information processing apparatus is a device with a communication function such as wireless LAN, can execute an application program, and has a user interface. Various devices can be used, including a portable terminal, a notebook PC, a tablet terminal, a personal digital assistant (PDA), a digital camera, and the like. Also, in the present embodiment, a printer is used as an example of the communication apparatus, but no such limitation is intended. Various devices can be used as long as the device can wirelessly communicate with the information processing apparatus. The printing system of the printer is not particularly limited, and an inkjet printer, a full color laser printer, a monochrome printer, or the like can be used. Also, a copy machine or a facsimile machine, a portable terminal, a smartphone, a notebook PC, a tablet terminal, a PDA, a digital camera, a music playback device, a television, or the like can be used as the communication apparatus. A multi-function peripheral provided with a plurality of functions, such as a copying function, a FAX function, a printing function, and the like, may also be used. Furthermore, a device that can be operated from a portable terminal such as a lighting fixture, an air conditioner, or a similar home appliance can be used.

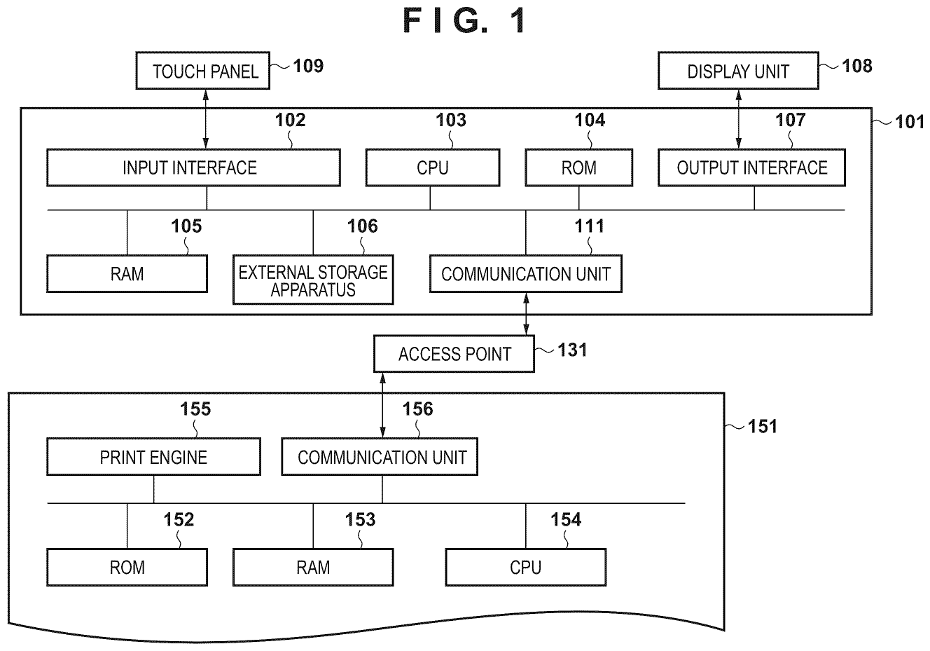

First, the configuration of the information processing apparatus according to the present embodiment and the configuration of the communication apparatus that can communicate with the information processing apparatus according to the present embodiment will be described with reference to the block diagram of FIG. 1. In the present embodiment, the following configuration is an example. However, the present embodiment can be applied to any device that can communicate with a communication apparatus, and the functions are not particularly limited to those in the drawings.

### Information Processing Apparatus Hardware

An information processing apparatus 101 includes an input interface 102, a CPU 103, a ROM 104, a RAM 105, an external storage apparatus 106, an output interface 107, a display unit 108, a communication unit 111, and the like.

The input interface 102 is an interface for accepting data input and operation instructions from a user via the operation of a touch panel 109.

The CPU 103 is a system control unit that executes programs stored in the ROM 104 and the RAM 105 and controls the entire information processing apparatus 101.

The ROM 104 stores fixed data, such as data tables, and control programs executed by the CPU 103, such as a built-in operating system (hereinafter referred to as OS) program, and the like. In the present embodiment, the respective control programs stored in the ROM 104 control the execution of software, such as scheduling, task switching, and interrupt processing, under the management of the built-in OS stored in the ROM 104.

The RAM 105 is constituted by a static random-access memory (SRAM) and the like that requires a backup power supply. Note that because the RAM 105 stores the data via a non-illustrated primary cell for data backup, the data required for program-controlled variables and the like can be stored without volatilization. Also, the RAM 105 is also provided with a memory area for storing setting information of the information processing apparatus 101, management data of the information processing apparatus 101, and the like. The RAM 105 is also used as the main memory and the working memory of the CPU 103.

The external storage apparatus 106 stores an application for providing a print execution function, a printing information generation program for generating printing information that can be interpreted by a communication apparatus 151, and the like. Also, the external storage apparatus 106 stores the various types of programs, such as an information transceiving control program for transceiving with the communication apparatus 151 connected via the communication unit 111, and various types of information used by the programs.

The output interface 107 is an interface for performing control for the display unit 108 to display data and communicate the state of the information processing apparatus 101. The CPU 103 can transmit image data stored in the RAM 105 or the like to the display unit 108 via the output interface 107 for display.

The display unit 108 is constituted by a light-emitting diode (LED), a liquid crystal display (LCD), or the like and displays data and communicates the state of the information processing apparatus 101. Note that by place an operation unit such as a numerical value input key, a mode setting key, an enter key, a cancel key, a power key, and the like on the display unit 108, input from a user can be accepted via the display unit 108. In this case, the display unit 108 is constituted by a touch-panel-equipped display with a touch panel 110 layered on top, and the displayed operation units and the positions for accepting the operations on the touch panel being associated together.

The communication unit 111 is configured to connect to an apparatus, such as the communication apparatus 151 or an access point 131, and perform data communication. The communication unit 111 may be a network adapter or a communication adapter, a piece of hardware called a network interface card (NIC), or the like. For example, the communication unit 111 can connect to an access point (not illustrated) inside the communication apparatus 151. By connecting the communication unit 111 and an access point inside the communication apparatus 151, the information processing apparatus 101 and the communication apparatus 151 can communicate with one another. Note that the communication unit 111 may communicate directly with the communication apparatus 151 via wireless communication or may communicate via an external apparatus located outside of the information processing apparatus 101 and the communication apparatus 151. The external apparatus includes an external access point (the access point 131 or the like) or an apparatus that can rely communications other than an access point located outside of the information processing apparatus 101 and outside of the communication apparatus 151. Examples of the wireless communication system include, for example, Wi-Fi (WirelessFidelity) (registered trademark), Bluetooth (registered trademark), and the like.

Examples of the access point 131 include, for example, a wireless LAN access point, a wireless LAN router with a built-in access point, or a similar device. Note that in the present embodiment, the method of connecting the information processing apparatus 101 and the communication apparatus 151 directly without using an external access point is referred to as a direct connection method. Also, the method of connecting the information processing apparatus 101 and the communication apparatus 151 via an external access point is referred to as an infrastructure connection method.

Note that the information processing apparatus 101 according to the present embodiment is assumed to be a smartphone, tablet terminal, or the like. However, in a case where a general-purpose computer such as a personal computer is used, a keyboard, mouse, or the like may be used as the input device. Also, a second communication unit that communicates via a communication medium different from that of the communication unit 111 may be provided. For example, the communication unit 111 may communicate using wireless LAN, and the second communication unit may communicate using a different medium such as Bluetooth (registered trademark).

### Communication Apparatus Hardware

The communication apparatus 151 is a communication apparatus according to the present embodiment. The communication apparatus 151 includes a ROM 152, a RAM 153, a CPU 154, a print engine 155, a communication unit 156, a notification sound generation unit 157, and the like.

The communication unit 156 includes, as an access point inside the communication apparatus 151, an access point for connecting to an apparatus such as the information processing apparatus 101. Note that this access point can connect to the communication unit 111 of the information processing apparatus 101. Note that the communication unit 156 may directly communicate with the information processing apparatus 101 via wireless communication or may communicate via the access point 131. Examples of the communication system include, for example, Wi-Fi (registered trademark) and the like. Also, the communication unit 156 may be provided with hardware that functions as an access point or may operate as an access point by the CPU 154 executing software for causing it to function as an access point.

The RAM 153 is constituted by an SRAM and the like that requires a backup power supply. Note that because the RAM 153 stores the data via a non-illustrated primary cell for data backup, the data required for program-controlled variables and the like can be stored without volatilization. The RAM 153 is also provided with a memory area for storing setting information of the communication apparatus 151, management data of the communication apparatus 151, and the like. Also, the RAM 153 is used as the main memory and the working memory of the CPU 154 and stores a receiving buffer for temporarily storing the printing information received from the information processing apparatus 101 or the like and various types of information.

The ROM 152 stores fixed data, such as a control program executed by the CPU 154, data tables, an OS program, and the like. In the present embodiment, the respective control programs stored in the ROM 152 control the execution of software, such as scheduling, task switching, and interrupt processing, under the management of the built-in OS stored in the ROM 152.

The CPU 154 is a system control unit that executes programs stored in the ROM 152 and the RAM 153 and controls the entire communication apparatus 151.

An image is formed on a printing medium by applying a printing agent such as ink on a printing medium such as paper on the basis of information stored in the print engine 155, the RAM 153 or a print job received from the information processing apparatus 101, and the printing result is output.

Note that the communication apparatus 151 may be installed with a memory, such as an external HDD, SD card, or the like, as an optional device, and the information stored in the communication apparatus 151 may be stored on this memory.

Also, the communication apparatus according to the present embodiment communicates with the information processing apparatus via a communication mode based on a connection mode which is set by connection setting processing described below. The communication apparatus according to the present embodiment has an infrastructure connection mode set as the connection mode in a case where communication is performed via an infrastructure connection and a direct connection mode set as the connection mode in a case where communication is performed via a direct connection.

In the infrastructure connection mode, the information processing apparatus 101 and the communication apparatus 151 communicate via the access point 131. In the direct connection mode, the information processing apparatus 101 and the communication apparatus 151 communicate 1-on-1 (also referred to as P2P) and are connected. In the direct connection mode, the information processing apparatus 101 and the communication apparatus 151 communicate via the access point built into the communication apparatus 151. As the P2P connection mode, instead of the direct connection mode, an ad hoc connection mode that does not go through an access point may be used. Also, in a case where a P2P connection is possible using another communication unit and not communication via the communication unit 111 and the communication unit 156, communication between the information processing apparatus 101 and the communication apparatus 151 may be implemented using this P2P connection.

In this example, the sharing of the processing load between the information processing apparatus 101 and the communication apparatus 151 has been described above, but the load sharing is not particularly limited to this example and may take another form.

### Information Processing Apparatus Application

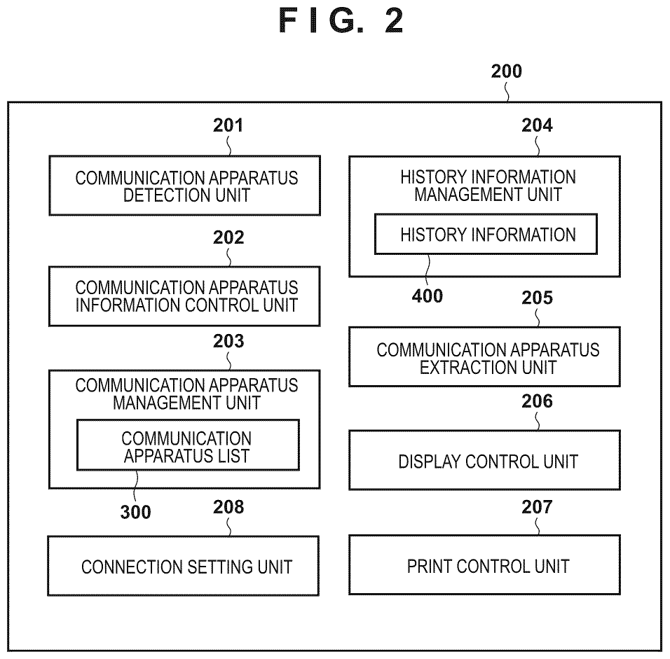

FIG. 2 illustrates the configuration of a predetermined application stored in the ROM 104, the external storage apparatus 106, or the like of the information processing apparatus 101. Note that the predetermined application is an application for setting the settings of the access point of the connection destination of the communication apparatus 151, causing the communication apparatus 151 to print image data, document data, and the like in the information processing apparatus 101, and the like. Also, it may have a function for causing the information processing apparatus 101 to take in image data, document data, and the like scanned by the communication apparatus 151. Such an application is referred to hereinafter as a printing application.

A printing application 200 includes, as program modules, a communication apparatus detection unit 201, a communication apparatus information control unit 202, a communication apparatus management unit 203, a history information management unit 204, a communication apparatus extraction unit 205, and a display control unit 206. A print control unit 207 and a connection setting unit 208 are also provided. Each program module is executed by the CPU 103 to implement the corresponding function.

In the present embodiment, the printing application 200 searches for the communication apparatus 151 connected on the network of the access point 131 to which the information processing apparatus 101 is connected using the communication apparatus detection unit 201. Also, whether or not the communication apparatus 151 extracted by the communication apparatus extraction unit 205 described below is in the network which the information processing apparatus 101 belongs to is detected, and whether the communication apparatus 151 is in a usable state is confirmed. In other words, in a case where the power of the communication apparatus is turned off or the communication apparatus is in an offline state with respect to the network, the communication apparatus is not detected by the communication apparatus detection unit 201.

The communication apparatus information control unit 202 communicates with the found communication apparatus 151 via the communication unit 111 described above and obtains the capability information of the communication apparatus. Also, the communication apparatus information control unit 202 stores the obtained capability information in the communication apparatus management unit 203 described below and then registers the communication apparatus in a communication apparatus list as a communication apparatus that can execute communication and printing. In other words, processing to register the communication apparatus includes processing to obtain capability information from the communication apparatus via the printing application, processing to store the obtained capability information via the printing application, and processing to manage the communication apparatus, which is the source of the obtained capability information, via the printing application. Also, the communication apparatus list is stored by the printing application. Thus, registering a communication apparatus in the communication apparatus list can be paraphrased as registering a communication apparatus in the printing application.

Also, in the present embodiment, the printing application transmits print jobs and scan jobs to communication apparatuses registered in the printing application. In other words, the printing application cannot transmit print job and scan jobs to communication apparatuses not registered in the printing application. This is because the option items (print settings item and scan settings item) that the user can set for a print job or a scan job transmitted to the communication apparatus are displayed on the basis of the capability information of the communication apparatuses. Specifically, control is performed so that, on a print settings screen or a scan settings screen, the options corresponding to the capability information of the communication apparatus are displayed and options not corresponding to the capability information of the communication apparatus are not displayed. Accordingly, setting values not corresponding to the communication apparatus may be stopped from being selected for the print settings and the scan settings.

Also, in the present embodiment, the printing application can register a plurality of communication apparatuses in the printing application. In a case where a plurality of communication apparatuses are registered in the printing application, it is necessary to control which one of the plurality of registered communication apparatuses to set as the job transmission destination. Thus, in a case where a plurality of communication apparatuses are registered in the printing application, the printing application selects a communication apparatus to be set as the job transmission destination from the plurality of registered communication apparatuses. This selection may be performed by displaying the plurality of registered communication apparatuses and accepting a selection from these from the user. Alternatively, this selection may be performed by the communication apparatus extraction unit 205 described below extracting one of the communication apparatuses. In the present embodiment, a communication apparatus that is set as the job transmission destination and selected by the printing application is referred to as the selected communication apparatus. Also, in the present embodiment, print jobs and scan jobs are transmitted to the selected communication apparatus.

Note that in a case where only one communication apparatus is registered in the printing application, this communication apparatus may be automatically selected as the selected communication apparatus at the time when the communication apparatus is registered. Also, a communication apparatus registered in the printing application may be able to be changed to a state of being unregistered in the printing application. In other words, the registration of a communication apparatus may be able to be cancelled from the printing application. Specifically, for example, the printing application may display a list of the registered communication apparatuses and accept an operation from the user for cancelling the registration of a communication apparatus selected from the list to cancel the registration of the communication apparatus. When the registration of a communication apparatus is cancelled, the printing application deletes the various types of information (capability information and the like) obtained from the communication apparatus. Also, in the case of cancelling the registration of a communication apparatus, information of the communication apparatus is deleted also from the history information described below.

The communication apparatus management unit 203 is a configuration for storing the information of the communication apparatus 151 registered by the communication apparatus information control unit 202, with the information being stored in the ROM 104, the external storage apparatus 106, or the like.

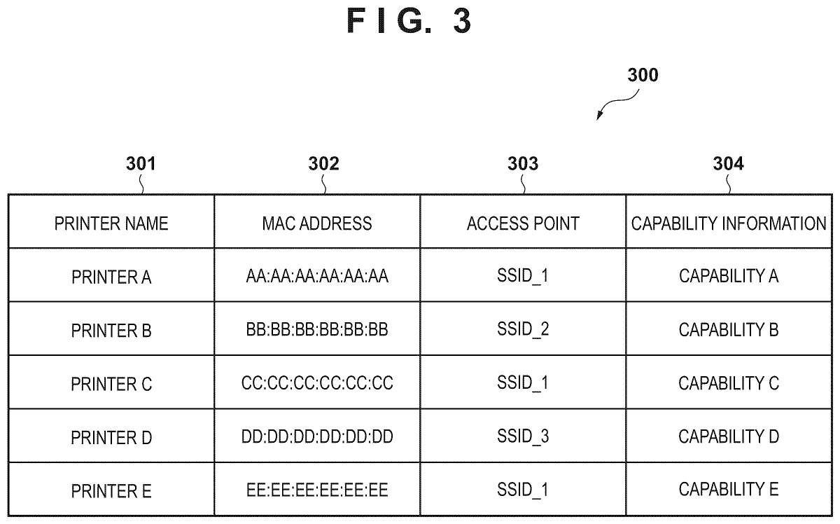

FIG. 3 illustrates a list of the registered communication apparatuses held by the communication apparatus management unit 203. In FIG. 3, the communication apparatuses are listed as printers. A communication apparatus list 300 holds names 301 of registration target communication apparatuses and their MAC addresses 302, SSIDs 303 of the access points connected to when registering the registration target communication apparatuses, and capability information 304 of the registration target communication apparatuses 151 associated together. The MAC addresses 302 are identification information unique to the network interface and are device information used for identifying the communication apparatuses.

The history information management unit 204 stores the communication apparatuses corresponding to each access point in the ROM 104, the external storage apparatus 106, or the like separate from the communication apparatus list 300 described above. When registration is performed by the communication apparatus information control unit 202, the SSID of the access point the information processing apparatus 101 is connected to is associated with the printer name, that is, the identification information of the communication apparatus, to be registered in the communication apparatus list 300 by the communication apparatus management unit 203 and registered as history information. Note that the communication apparatus corresponding to each access point may be a communication apparatus that has previously connected to the access point via wireless communication such as wireless LAN or a communication apparatus that can connect. A communication apparatus that can connect may be a communication apparatus found by a search by the access point, for example. Conversely, it may be a communication apparatus that has received a beacon from the access point. Also, registration of a communication apparatus to the history information is executed via processing to register a communication apparatus in the printing application by obtaining the capability information as described above. Thus, a communication apparatus registered in the history information is also a communication apparatus registered in the printing application as a selected communication apparatus candidate.

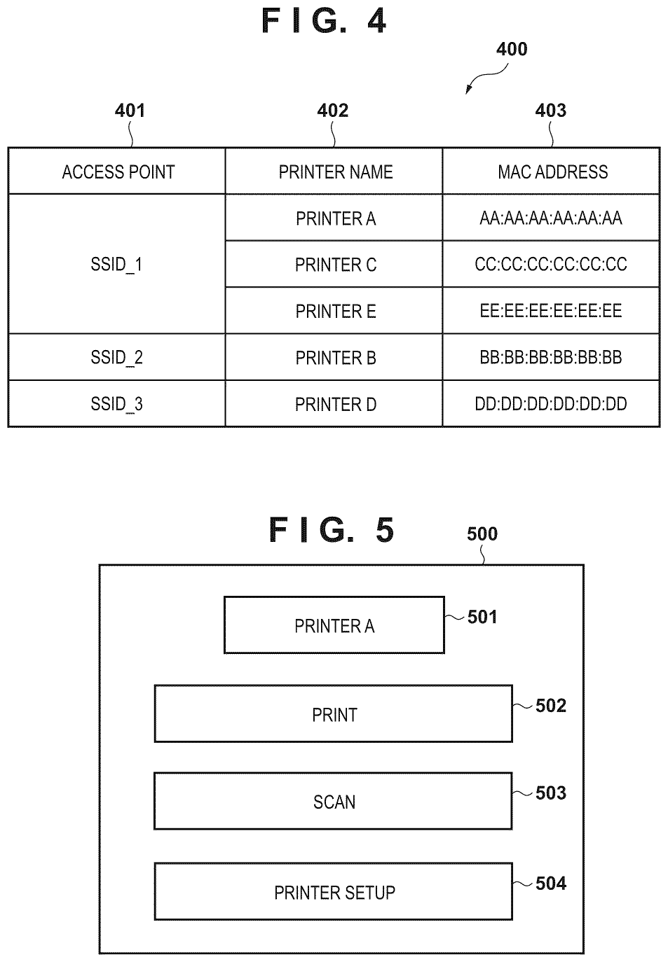

FIG. 4 illustrates an example of history information stored in the history information management unit 204. In the example illustrated in FIG. 4, the communication apparatus is a printer. History information 400 associates together names 402 of the communication apparatuses registered by the communication apparatus information control unit 202 and MAC addresses 403 of the communication apparatuses with SSIDs 401 of the access points the information processing apparatus is connected to at the time of registration and is stored by the history information management unit 204. Also, the history information and the communication apparatus that is the target for execution of a function including registration, printing of image data, document data, or the like, scanning, and the like are arranged at the top position per access point. In other words, the last used communication apparatus is removed from the top position, and the communication apparatuses are sorted by the most recent use history per access point. When a communication apparatus matching the condition is selected from the history information 400, if there are a plurality of communication apparatuses, the communication apparatus closest to the top position, that is, last used, may be selected.

The communication apparatus extraction unit 205 obtains the history information 400 stored in the history information management unit 204. The communication apparatus corresponding to the access point the information processing apparatus 101 is connected to is extracted from the obtained history information 400. In other words, a communication apparatus that is highly likely to be made to print by the printing application 200 is extracted. The history information 400 rearranges the extracted communication apparatus to be at the top position of the communication apparatuses corresponding to the associated access point.

The display control unit 206 displays that the communication apparatus 151 extracted by the communication apparatus extraction unit 205 is in a selectable state on the display unit 108. Here, selectable state means a state of being designated as the target for execution of a function including printing of image data, document data, or the like, scanning, and the like.

The print control unit 207 transmits the selected document data to be printed to the selected printer (communication apparatus 151) and causes the printer to print the document data. The document data to be printed may be, for example, a document open at the time the printing application 200 was started up. Naturally, another method may be used for selection, and the selection may be made after the printing application 200 is started up.

The connection setting unit 208 executes connection setting processing to set the connection between the access point 131 or the communication apparatus 151. Detection of the communication apparatus, transmission of the document data to the communication apparatus, and the like is executed via the set connection. In addition, the printing application 200 may include a software module for controlling the other functions of the printer such as a scanner function, for example.

Note that hereinafter, the processing described as processing executed by a configuration in the printing application, the configuration illustrated in FIG. 2, more accurately means processing implemented by the CPU 103 reading out the printing application stored in the ROM 104 or the like onto the RAM 105 and executing the printing application.

### Start-Up Screen of Printing Application

FIG. 5 is an example of a start-up screen displayed on the display unit 108 when the printing application 200 is started up. The start-up screen is a user interface for causing the printing application 200 to operate in response to an operation received from a user and includes various types of display portions, buttons, and the like. Note that the start-up screen is a home screen.

The user can use the functions of the communication apparatus including printing a desired image or setting the settings of the communication apparatus via a start-up screen 500. The display control unit 206 displays, on a printer display portion 501, an image, text, or the like indicating the communication apparatus 151 extracted by the communication apparatus extraction unit 205 to indicate to the user that the communication apparatus 151 is in a selectable state. In other words, various types of information relating to the communication apparatus identified as the selected communication apparatus is displayed in the printer display portion 501. Various types of information relating to the communication apparatus identified as the selected communication apparatus specifically means, for example, the model name of the communication apparatus, information indicating whether or not the communication apparatus and the information processing apparatus 101 can communicate, and a diagram illustrating the external appearance of the communication apparatus. Here, extracting can be substituted with identifying the target compatible with the condition. Also, the selected communication apparatus indicates the communication apparatus currently selected as the apparatus for causing execution of a predetermined processing such as printing by the communication apparatus.

Note that in the present embodiment, even if a plurality of communication apparatuses are registered in the printing application, on the start-up screen, only the information relating to the selected communication apparatus from among the plurality of communication apparatuses registered in the printing application is displayed, and the information relating to the other communication apparatuses is not displayed. However, no such limitation is intended, and on the start-up screen, information relating to the plurality of communication apparatuses registered in the printing application may be displayed. In this example, an icon or key indicating which one of the plurality of communication apparatuses registered in the printing application is the selected communication apparatus may be displayed. Also, on the start-up screen, a region for changing the selected communication apparatus to another communication apparatus from among the plurality of communication apparatuses registered in the printing application may be provided. When this region is operated, a list of the plurality of communication apparatuses registered in the printing application is displayed, and the communication apparatus selected from the list is identified as the new selected communication apparatus.

When the press of a print button 502 is detected, the information processing apparatus 101 uses the print control unit 207 to cause the selected communication apparatus 151 to execute printing. Also, when a press of a scan button 503 is detected, the information processing apparatus 101 causes the communication apparatus 151 to execute scanning.

Also, when a press of a printer setup button 504 is detected, the information processing apparatus 101 starts the connection setting processing using the connection setting unit 208. The connection setting processing executed in response to a press of the printer setup button 504 is processing to set the connection of a direct connection mode using the access point included in the communication apparatus 151. Note that to execute the connection setting processing for the communication apparatus 151 in response to a press of the printer setup button 504, the communication apparatus 151 must be transitioned to the connection setting mode. The connection setting mode is a mode the communication apparatus 151 is set to when setting the connection mode for the communication apparatus 151, and when a predetermined input is performed by the user on the input interface (not illustrated) provided on the communication apparatus 151, the communication apparatus 151 is set to this mode. For example, when connecting the information processing apparatus 101 and the communication apparatus 151 via the direct connection mode, the communication apparatus 151 is operated and set to the direct connection mode. Thereafter, when the printer setup button 504 is pressed, the connection setting processing is executed, the access point built into the communication apparatus 151 is connected to, and the information processing apparatus 101 can communicate with the communication apparatus 151 in the direct connection mode.

### Start-Up Processing of Printing Application

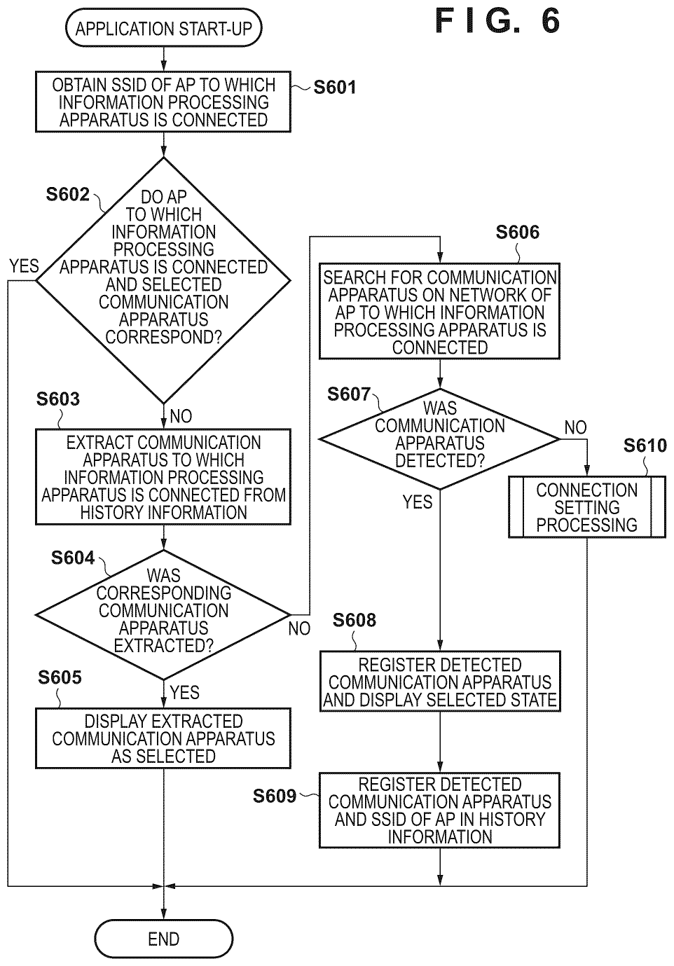

FIG. 6 is a flowchart illustrating the flow of the processing executed when the printing application 200 is started up. The flowchart illustrated in FIG. 6 is the processing for selecting an appropriate communication apparatus according to the access point the information processing apparatus 101 is connected to at the time of application start-up. The present flowchart is implemented by the CPU 103 reading out a program (printing application) stored in the ROM 104 onto the RAM 105 and executing the program. In a case where an element of the software configuration of FIG. 2 is described as the executing subject in the flowchart, the executing subject of the hardware is the CPU 103. Note that in the flowchart, the access point is indicated as AP.

First, in S601, the CPU 103 obtains the service set identifier (SSID) of the access point 131 the communication unit 111 is connected to from the OS installed on the information processing apparatus 101. Note that here, the access point 131 the communication unit 111 is connected to corresponds to the access point 131 the communication unit 111 is connected to upon application start-up. Also, the information of the access point 131 the communication unit 111 is connected to is obtained by the OS from the access point 131 before communication is started. The information of the access point 131 the communication unit 111 is connected to may be obtained from a beacon of a Wi-Fi standard emitted by the access point 131, for example. Also, the information may be obtained by querying the access point 131 after a beacon is obtained and a Wi-Fi connection is established. Note that the information of the access point 131 the communication unit 111 is connected to is not limited to being obtained from the OS and, for example, may be obtained by the CPU 103 querying the access point 131 in S301.

In S602, the communication apparatus information control unit 202 of the printing application 200 determines, via the communication apparatus management unit 203, whether the currently selected communication apparatus (selected communication apparatus) corresponds to the SSID obtained in S601. In a case where the determination results shows no correspondence, the processing of S603 is executed. If the connected access point and the selected communication apparatus are associated together in the history information 400, for example, in the determination of S602, the communication apparatus may be determined to correspond to the obtained SSID. In a case where it is determined that there is a correspondence, the selected communication apparatus is the communication apparatus registered as corresponding to the connected access point, and thus the processing ends. Note that in a case where there is not selected communication apparatus, the processing may branch to S603. A case where there is not selected communication apparatus is a case where not one communication apparatus is registered in the printing application.

In S603, the communication apparatus extraction unit 205 performs extraction of the communication apparatus corresponding to the SSID obtained in S601 via the history information management unit 204. The access point SSID and the identification information of the communication apparatus are associated together in the history information 400. Thus, the communication apparatus corresponding to the obtained SSID may be identified by referencing the history information 400 for extraction. Here, the communication apparatus extraction unit 205 performs communication with the extracted communication apparatus via the communication unit 111 and confirms that the communication apparatus is online. In other words, it confirms that connection is possible. Also, in a case where there are a plurality of communication apparatuses that correspond to the SSID, the communication apparatus with the most recent use history (last used) may be extracted, or from the plurality of communication apparatuses, a communication apparatus that can communicate with the information processing apparatus and with a recent use history may be extracted.

In S604, the communication apparatus information control unit 202 determines whether or not a communication apparatus extracted in S603 exists. In a case where it is determined that one exists, the processing of S605 is executed. In a case where it is determined that one does not exist, the processing of S606 is executed.

In S605, the communication apparatus information control unit 202 sets the communication apparatus extracted in S603 as the selected communication apparatus. In other words, the communication apparatus information control unit 202 sets the communication apparatus extracted in S603 in a selected state, and the display control unit 206 displays an image, text, or the like indicating the communication apparatus on the printer display portion 501 of the start-up screen 500.

In S606, the communication apparatus detection unit 201 searches for the communication apparatus connected on the network of the access point 131 the information processing apparatus 101 is connected to via the communication unit 111.

In S607, the communication apparatus detection unit 201 determines whether a communication apparatus has been detected in S606. In a case where it is determined that a communication apparatus has been detected, the communication apparatus determines that a function such as printing can be executed and executes the processing of S608. In a case where it is determined that a communication apparatus has not been detected, a usable communication apparatus is not connected on the network. Thus, connection settings to make a new communication apparatus usable are performed in S610. Note that in a case where the SSID of the connected access point cannot be obtained in S601, the processing branches through S604 and S607 and proceeds to S610. In a case where a plurality of communication apparatuses are detected in S607, a list of the detected communication apparatuses may be displayed on the user interface, and the user may be made to select one or one may be selected in a discretionary manner. The criteria for selection may be height of the radio wave intensity (highest is selected), order of being found (first is selected), or the like.

In S608, the communication apparatus information control unit 202 uses the communication unit 111 to obtain the capability information from the communication apparatus detected in S606 and executes processing to register this in the communication apparatus list 300 together with the MAC address and the access point SSID. Also, the communication apparatus registered here is set as the selected communication apparatus. In other words, the communication apparatus information control unit 202 displays the registered communication apparatus in the printer display portion 501 of the start-up screen 500 in a selected state. In S608, in a case where a plurality of communication apparatuses are detected, the processing of S608 is executed on the selected communication apparatus.

In S609, the communication apparatus information control unit 202 associates together the communication apparatus registered in S608 and the SSID of the access point the communication unit 111 is connected to and registers them in the history information management unit 204.

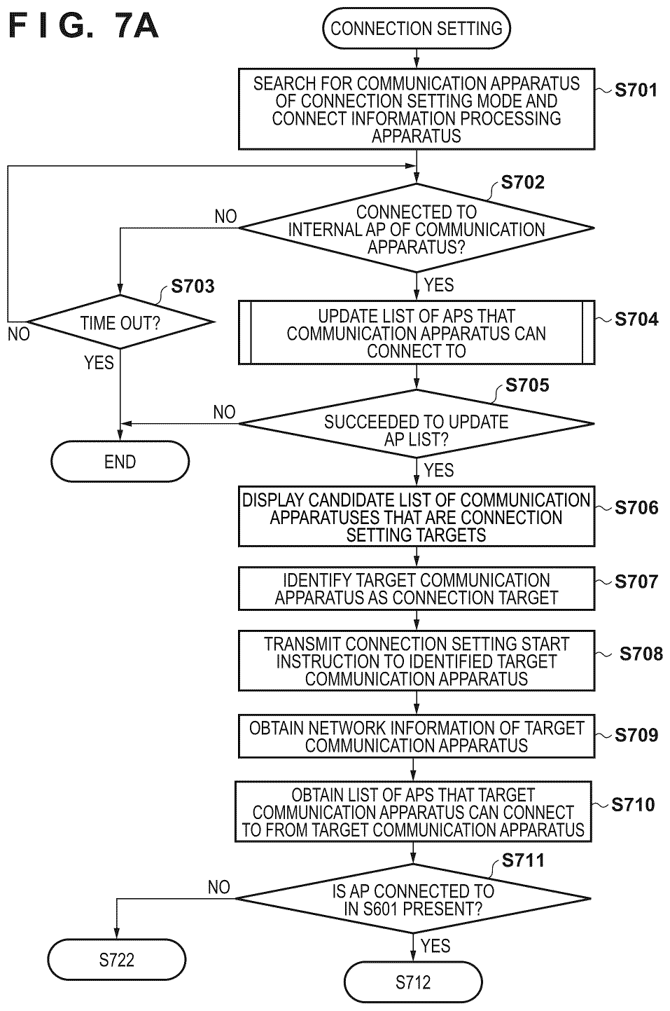

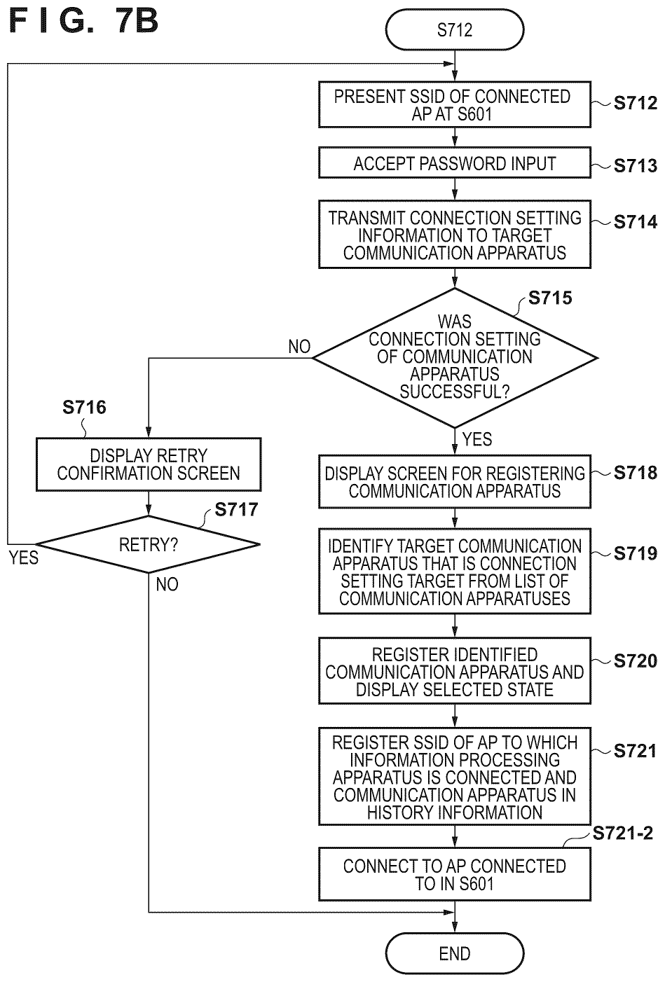

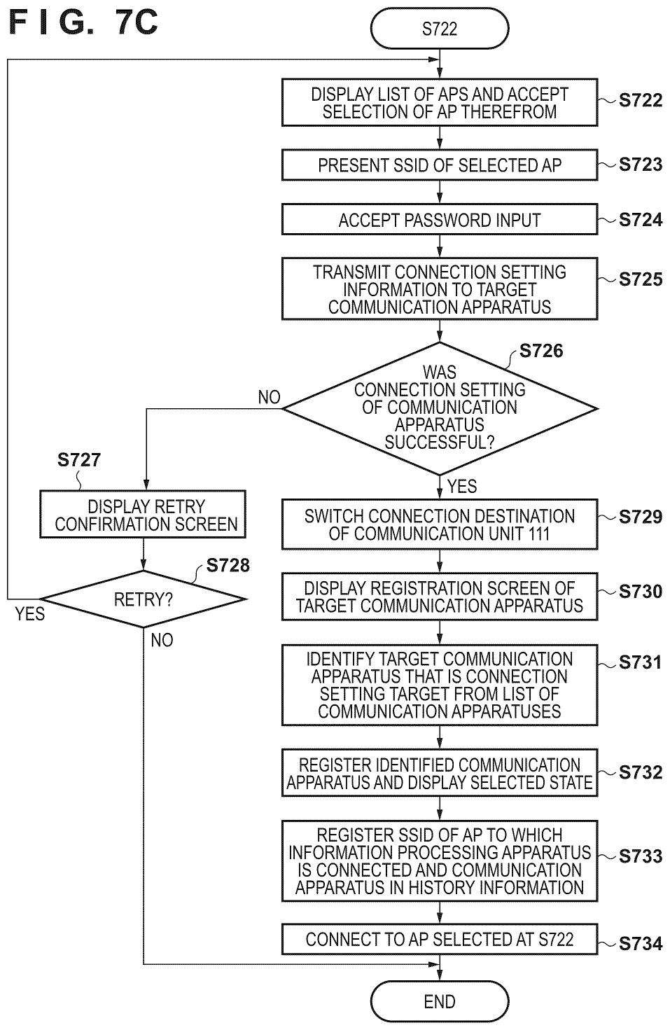

The connection setting processing of S610 executed by the connection setting unit 208 will now be described using FIGS. 7A to 7C. In S610, the connection setting unit 208 attempts a direct connection with the communication apparatus 151 in connection setting mode. If the connection is successful, using this connection, the connection setting unit 208 identifies access points to which one communication apparatus that can form a direct connection with the information processing apparatus can connect. If the identified access points include the initially connected access point, the directly-connected communication apparatus is set as the selected communication apparatus and registered in the history information in association with the initially connected access point. Also, if the identified access points do not include the initially connected access point, the directly-connected communication apparatus is set as the selected communication apparatus and registered in the history information in association with the access point selected from the identified access points. This process will be described below. The flowchart of FIGS. 7A to 7C is implemented by the CPU 103 reading out a program (printing application) stored in the ROM 104 onto the RAM 105 and executing the program. Note that the executing subject of the software of the flowchart of FIGS. 7A to 7C is the connection setting unit 208.

In S701, the CPU 103 starts the connection settings to switch the connection destination of the communication unit 111 to the communication apparatus 151 that can execute connection setting processing. For example, there is a communication apparatus that can execute the connection setting processing using Wi-Fi. In a case where such a communication apparatus is in the connection setting mode, for example, an internal access point that is enabled only during connection setting mode is enabled. Accordingly, by detecting a beacon being transmitted according to the Wi-Fi standard by the internal access point, the CPU 103 can discover a communication apparatus in the connection setting mode. Also, the internal access point includes a fixed SSID that cannot be discretionarily changed by the user, for example. Then, if it is a communication apparatus in the connection setting mode, the communication apparatus, in particular, the internal access point, is connected to. Note that in a case where any one of the access points are connected to at the point in time of S701, this connection is cancelled before the connection (direct connection) is attempted.

In S702, the CPU 103 determines whether or not the connection destination of the communication unit 111 has switched to the internal access point of the communication apparatus 151. Specifically, the CPU 103 obtains the SSID of the access point the communication unit 111 is connected to from the OS of the information processing apparatus 101 and determines whether or not a character string indicating the internal access point of the communication apparatus 151 is included in the SSID.

In a case where it is determined that the communication unit 111 is connected to the internal access point of the communication apparatus 151, in S704, the CPU 103 executes update processing on the list of access points that the communication apparatus can connect to. On the other hand, in a case where it is determined that the communication unit 111 is not connected to the internal access point of the communication apparatus 151, the CPU 103 executes the processing of S703 and determines whether or not a predetermined amount of time has passed (time out) from when the connection setting processing was started. In a case where it is determined that a time out has not occurred, the CPU 103 executes the processing of S702 again. In a case where it is determined that a time out has occurred, the CPU 103 ends the processing. Note that here, the CPU 103 may display a screen for notifying the user of the time timing out on the display unit 108.

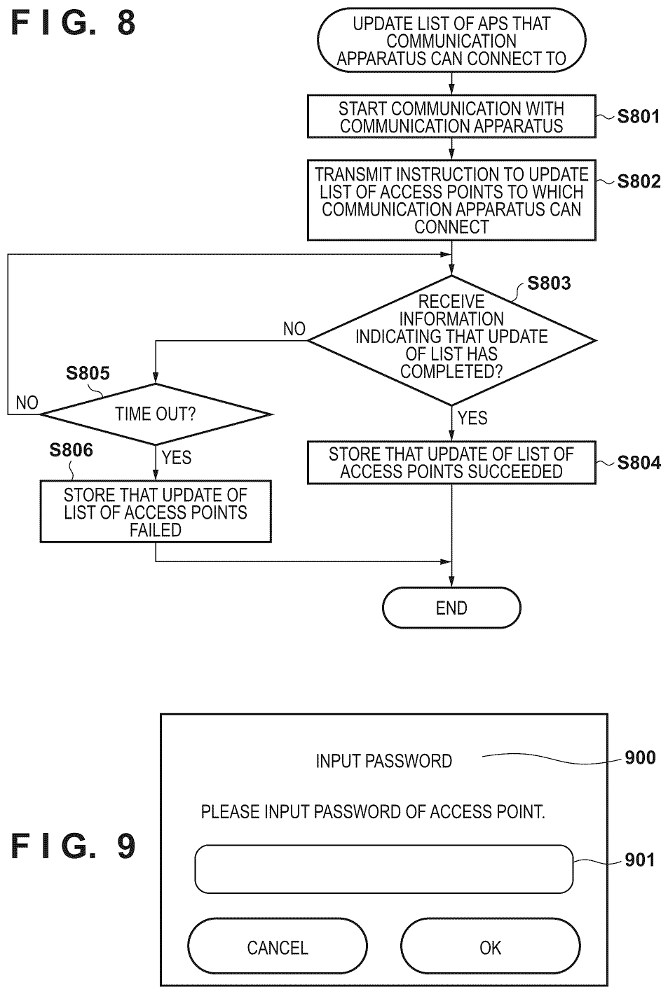

In S704, the CPU 103 requests the communication apparatus 151 to update the list of external access points the communication unit 156 can connect to using communication via the communication unit 111. Here, the list requested to be updated is a list of information for identifying the external access points the communication unit 156 can connect to, and the information for identifying the external access points may be SSIDs, for example. The details of the processing of S704 will now be described using FIG. 8.

FIG. 8 is a flowchart illustrating the flow of the processing of S704. The flowchart illustrated in FIG. 8 is implemented by the CPU 103 reading out a program (printing application) stored in the ROM 104, the external storage apparatus 106, or the like onto the RAM 105 and executing the program, for example.

In S801, the CPU 103 transmits a communication start request to the communication apparatus 151 for the internal access point of the connected communication apparatus 151. When the communication start request is received by the communication apparatus 151, communication between the communication apparatus 151 and the information processing apparatus 101 is started.

In S802, the CPU 103 transmits, to the communication apparatus 151, an instruction to update (or a request to update) the list of the external access points the communication unit 156 can connect to by communicating via the communication unit 111 (instruction transmission step).

In a case where the update of the list of external access points that the communication unit 156 can connect to is successful (completed) for the communication apparatus 151, the CPU 103 can obtain information indicating this via the communication unit 111. Here, in S803, the CPU 103 determines whether or not the information indicating that the update of the list of external access points the communication unit 156 can connect to has been successful (completed) has been received by the communication unit 111. In a case where it is determined that the communication unit 111 has received the information indicating that the update of the list of external access points the communication unit 156 can connect to has been successful, the CPU 103 executes the processing of S804. In S804, the CPU 103 stores the determination information indicating that the update of the list of external access points the communication unit 156 can connect to has been successful in the RAM 105.

On the other hand, in a case where it is determined in S803 that the communication unit 111 has not received the information indicating that the update of the list of external access points the communication unit 156 can connect to has been completed, the CPU 103 executes the processing of S805. In S805, the CPU 103 determines whether or not a predetermined amount of time has passed (time out) from when the instruction to update the list of access points was transmitted. In a case where it is determined that a time out has not occurred, the CPU 103 executes the processing of S803 again. In a case where it is determined that a time out has occurred, the CPU 103 executes the processing of S806, then ends the processing. Note that here, the CPU 103 may display a screen for notifying the user of the time timing out on the display unit 108. In S806, the CPU 103 stores the determination information indicating that the update of the list of external access points the communication unit 156 can connect to has been unsuccessful in the RAM 105. The determination information is used in the subsequently described determination processing.

According to the process described above, in S704, the communication apparatus 151 attempts to update the list of the access points the communication apparatus 151 can access and whether the update result is success or not a success (failure) is stored.

Next, we will return to the processing of the flowchart illustrated in FIG. 7A. In S705, the CPU 103 determines whether or not the update of the list of external access points the communication unit 156 can connect to has been successful. Here, the CPU 103 reads out the determination information stored in the RAM 105 in S704 and performs the determination. In a case where it is determined that the update has been successful, the CPU 103 executes the processing of S706. On the other hand, in a case where it is determined that the update has been unsuccessful, the CPU 103 ends the processing.

In S706, the CPU 103 discovers communication apparatus candidates to be targeted for connection setting processing and displays a list (candidate list) of the discovered apparatuses on the display unit 108. Specifically, the CPU 103 first adds the communication apparatus with the connection established in S702 to the candidate list. Then, the CPU 103 adds the communication apparatuses in the connection setting mode to the candidate list via a known discovery process. The CPU 103 identifies, from among the detected beacons, a beacon of a fixed (that is, specific) SSID indicating an internal access point and adds the communication apparatus provided with the internal access point emitting the specific beacon to the candidate list. In other words, in the present embodiment, the communication apparatus with an enabled specific internal access point in the connection setting mode is displayed in the candidate list as a communication apparatus to be targeted for connection setting processing. The displayed candidate list may be a list of SSIDs of internal access points, for example.

Note that the communication apparatuses added to the candidate list are not limited to this example, and communication apparatuses transmitting specific beacon information in the connection setting mode may be added to the candidate list, for example. Also, the timing of executing the processing of S706 is not limited to this example, and the processing of S706 may be executed directly after S702, for example. Also, for example, in a case where, after performing communication apparatus discovery for a certain amount of time, only one communication apparatus has been added to the candidate list, the CPU 103 may not display the candidate list, proceed the processing to S707, and identify the one communication apparatus as the target apparatus. Also, in a case where, after performing communication apparatus discovery for a certain amount of time, no communication apparatuses have been added to the candidate list, the CPU 103 may display an error screen on the display unit 108 and end the connection setting processing. Also, the candidate list displayed on the display unit 108 may include information corresponding to the communication apparatus added to the candidate list. For example, information corresponding to the communication apparatus may be the MAC address or IP address of the communication apparatus or the SSID of the internal access point of the communication apparatus. A combination of this information may be displayed as a candidate list.

In S707, the CPU 103 accepts the selection of a communication apparatus by a user from the displayed list and identifies the communication apparatus (target apparatus) to be targeted for connection setting processing from among the communication apparatuses added to the candidate list. Note that, for example, in a case where, after performing communication apparatus discovery for a certain amount of time, only one communication apparatus has been added to the candidate list, the CPU 103 may automatically select the one communication apparatus without accepting a user selection. In a case where the target apparatus is identified, the CPU 103 executes the subsequent connection setting processing on the identified target apparatus.

Accordingly, for example, in a case where there are a plurality of candidates for the apparatus to be targeted for connection setting processing around the information processing apparatus 101, the user can be allowed to select the apparatus to be targeted for connection setting processing.

In S708, the CPU 103 transmits a connection setting start instruction to the communication apparatus 151 which is the target apparatus identified in S707 via the communication started in S701. Hereinafter, the communication apparatus 151 identified in S707 may also be referred to as the target communication apparatus or the target communication apparatus 151. Note that in a case where the communication apparatus connected in S701 and the target communication apparatus 151 identified in S707 are different, a direct connection with the target communication apparatus 151 may be retried before the processing of S708 onward is executed. In this case, communication with the target communication apparatus 151 is performed via a new connection in S709 and S710.

In S709, the CPU 103 obtains network information from the target communication apparatus 151 to be targeted for connection setting processing via the communication established in S701. Here, the network information stores the identification information (the MAC address of the communication apparatus 151 and the like) for detecting the target communication apparatus 151 via the access point 131. Note that in this example, the identification information is stored in the network information obtained in S709, but in another example, the identification information may be stored in beacon information obtained in S701. Also, the identification information may be stored in response data or the like transmitted by the communication apparatus 151 in response to a communication start request transmitted in S701.

In S710, the CPU 103 obtains a list (list information) of the access points the communication unit 156 can connect to from the target communication apparatus 151 via the communication established in S701 (list obtaining step). The list of the access points the communication unit 156 can connect to may be a list of SSIDs of the access points which are the transmission source of the beacons received by the communication apparatus 151, for example.

In S711, the CPU 103 determines whether or not the access point the communication unit 111 is connected to obtained in S601 is in the list of the access points the communication unit 156 of the target communication apparatus 151 can connect to obtained in S710. In a case where it is determined that the access point the communication unit 111 is connected to is in the list, the CPU 103 executes the processing of S712 (FIG. 7B). In a case where it is determined that the access point the communication unit 111 is connected to is not in the list, the CPU 103 executes the processing of S722 (FIG. 7C).

In S712 of FIG. 7B, the CPU 103 displays, on the display unit 108, the SSID obtained from the OS in S601 and a password input screen for using the access point (in this example, the access point 131) corresponding to the SSID. Here, for example, a screen 900 illustrated in FIG. 9 is displayed as the password input screen. The corresponding access point may be referred to as the target access point or the target access point 131. Note that in a case where a password for an access point that the information processing apparatus 101 has previously connected to is stored, the stored password may be used and the user input omitted. In this case, S712 and S713 are skipped.

In S713, the CPU 103 accepts a user input of the password for using the target access point 131. Here, the CPU 103 obtains the password information input by the user in an input portion 901.

Next, in S714, the CPU 103 transmits the connection setting information for registering the access point 131 as the connection destination of the target communication apparatus 151 to the target communication apparatus 151 via communication. Here, the connection setting information stores the SSID of the target access point 131 obtained in S601, the password obtained in S713 (or stored), a command for setting the connection mode of the communication apparatus 151, and the like. Note that in the present embodiment, the command for setting the connection mode of the target communication apparatus 151 is a command for setting the communication apparatus 151 to the infrastructure connection mode. When the target communication apparatus 151 receives the connection setting information, the target communication apparatus 151 connects to the target access point 131 using the received connection setting information.

In this manner, by the information processing apparatus 101 and the target communication apparatus 151 connecting to the same access point, the information processing apparatus 101 and the target communication apparatus 151 can establish an infrastructure connection and can communicate at high speeds via wireless LAN. Thus, thereafter, when the information processing apparatus 101 is instructed to execute transmission processing for a print job by a user, for example, wireless LAN communication between the information processing apparatus 101 and the target communication apparatus 151 is executed.

After the connection setting information is transmitted in S714, in S715, the CPU 103 determines whether or not the connection setting for the target access point 131 of the target communication apparatus 151 has been successful via the transmitted connection setting information. Specifically, first, the CPU 103 waits to receive a notification relating to the success or failure of the connection setting from the target communication apparatus 151. Then, when the CPU 103 receives the notification (is notified), the CPU 103 analyzes the contents of the notification and determines whether or not the connection setting of the target communication apparatus 151 was successful.

In a case where the connection setting of the target communication apparatus 151 was not successful, in S716, the CPU 103 displays, on the display unit 108, a screen for the user to confirm whether or not they wish to retry the connection setting of the target communication apparatus 151. Then, on the basis of the user input on the screen, the CPU 103 determines whether or not to retry the connection setting of the target communication apparatus 151. In the case of retrying the connection setting of the communication apparatus 151, the CPU 103 executes the processing of S712 onward again. In the case of not retrying the connection setting of the target communication apparatus 151, the CPU 103 ends the processing.

Also, in a case where the connection setting of the target communication apparatus 151 was successful, in S718, the CPU 103 displays, on the display unit 108, a screen (registration screen) for registering a certain communication apparatus as the communication destination of the information processing apparatus 101. A list is displayed on the registration screen of communication apparatuses operates as an access point and communication apparatuses connected to the access point the information processing apparatus 101 is connected to detected by executing a known discovery process. By selecting a certain communication apparatus from the list (list of registerable communication apparatuses) displayed on the registration screen, the selected communication apparatus is registered as the communication destination of the information processing apparatus 101.

In the present embodiment, the communication apparatus to be targeted for connection setting is registered as the communication destination of the information processing apparatus 101 without reception of a selection of a communication apparatus via user input. Thus first, in S719, the CPU 103 identifies the target communication apparatus 151 targeted for connection setting from among the list of registerable communication apparatuses on the basis of the identification information stored in the network information. Then, in S720, the CPU 103 displays the identified communication apparatus (in this example, the communication apparatus 151) in a manner indicating that it is selected from the displayed list and registers it as the communication destination of the information processing apparatus 101 in the communication apparatus list 300. This processing is similar to the processing of S608.

The processing of S721 is similar to the processing of S609. In other words, the CPU 103 registers the access point (target access point 131) the information processing apparatus 101 is currently connected to and the communication apparatus (target communication apparatus 151) connected via this access point in the history information 400.

Lastly, in S721-2, the CPU 103 reconnects to the access point that was connected in S601.

The processing of S722 onward is illustrated in FIG. 7C. In S711, in a case where there is no access point obtained in S601 in the list obtained in S710, in S722, the CPU 103 displays the list of access points the communication unit 156 can connect to obtained from the communication apparatus 151 in S710 on the display unit 108. The selection of a certain access point from the displayed list is received from the user.

In S723, the CPU 103 displays the SSID of the access point selected in S722 and displays the password input screen for using the access point corresponding to the SSID on the display unit 108. Here, for example, the screen 900 illustrated in FIG. 9 is displayed as the password input screen. Note that in a case where a password for an access point that the information processing apparatus 101 has previously connected to is stored, the stored password may be used and the user input omitted. In this case, S723 and S724 are skipped.

In S724, a user input of the password for using the access point selected in S716 is received. Here, the CPU 103 obtains the password information input by the user in the input portion 901.

In S725, the CPU 103 transmits the connection setting information for registering the access point selected in S723 as the connection destination of the target communication apparatus 151 to the target communication apparatus 151 via communication. Note that in a case where the communication apparatus connected in S701 and the target communication apparatus 151 are different, a direct connection with the target communication apparatus 151 may be retried before the processing of S725 is executed. The target communication apparatus 151 that receives the connection setting information attempts an infrastructure connection with the selected access point in accordance with the connection setting information.

The processing of S726 to S728 is similar to the processing of S715 to S717. Note that after the determination of S728, in the case of retrying the connection setting, the processing from S722 may be executed again or the processing from S723 may be executed again.

In S729, the CPU 103 switches the connection destination of the communication unit 111 to the access point selected in S722. Accordingly, the information processing apparatus 101 and the communication apparatus 151 are connected to the same access point, and communication in the infrastructure connection mode is enabled.

The processing of S730 to S733 is similar to the processing of S718 to S721. In other words, the CPU 103 displays, on the display unit 108, a screen (registration screen) for registering a certain communication apparatus as the communication destination of the information processing apparatus 101 (S730). A list is displayed on the registration screen of communication apparatuses operates as an access point and communication apparatuses connected to the access point the information processing apparatus 101 is connected to detected by executing a known discovery process. This is similar to S718.

Then, the CPU 103 identifies the communication apparatus 151 targeted for connection setting from among the list of registerable communication apparatuses on the basis of the identification information (SSID) stored in the network information (S731). The CPU 103 displays the identified communication apparatus 151 in a manner indicating that it is selected from the displayed list and registers it as the communication destination of the information processing apparatus 101 in the communication apparatus list 300 (S732). The CPU 103 of the information processing apparatus 101 registers the currently connected access point 131 and the communication apparatus 151 connected via this access point 131 in the history information 400 (S733).

Lastly, the CPU 103 connects to the access point selected in S722 (S734).

In a state with the processing of FIG. 6 ended, if the processing did not branch to S610, the information processing apparatus is connected to the SSID of the access point obtained in S601.

If the processing branched to S610 in FIG. 6 and to S712 at S711 in FIG. 7, in S721-2, it is re-connected with the access point that was connected at S601. Also, if the processing branched to S610 and to S722 at S711 in FIG. 7, in S734, it is re-connected with the access point selected in S722. In this manner, when the processing of FIG. 6 ends, the target communication apparatus 151 and the information processing apparatus 101 are both connected to the target access point 131. In this state, if there is an instruction to execute processing such as printing by the selected communication apparatus, the information processing apparatus 101 and the communication apparatus 151 are connected in the infrastructure connection mode via the access point 131, and thus printing can be quickly performed.

As described above, according to the present embodiment, a communication apparatus to be the target of the execution of a command can be automatically and appropriately put in a usable state depending on the status of the connection destination access point of the information processing apparatus and the connected communication apparatus. Since the function can automatically be made usable without the user manually selecting the communication apparatus to use, usability is improved. Note that a communication apparatus displayed in a selectable state can be re-selected by the user before an instruction to execute printing, for example, is transmitted to the communication apparatus. For example, when the printer display portion 501 is tapped, in the process of FIG. 6, a list of selection candidate communication apparatuses that were not selected may be displayed, and the user may select one from this list.

### Modified Example of First Embodiment

In the embodiment described above, the processing to obtain the information of the access point the information processing apparatus 101 is connected to from the OS is executed after communication with the communication apparatus is started. However, no such limitation is intended. In another example, the processing to obtain the information of the access point the information processing apparatus 101 is connected to from the OS may be executed before communication with the communication apparatus is started.

The embodiment described above was described using two communication paths, but two or more may be used. Also, an example in which the communication apparatus was not connected to the Internet was used, but no such limitation is intended.

Note that in S707, the timing for displaying the list of the candidates of the communication apparatuses to be targeted for connection setting processing and the timing for performing discovery of the candidates of the communication apparatuses to be targeted for connection setting processing are not limited to that described above. Other examples will now be described in detail.

For example, before communication with the communication apparatus is started, the CPU 103 may display a list of the candidates of the communication apparatuses to be targeted for connection setting processing or discovery of the candidates of the communication apparatuses to be targeted for connection setting processing may be performed. In this case, the list displays the communication apparatuses in the connection setting mode and the communication apparatuses which are the transmission source of the beacon information received by the information processing apparatus 101 found by a known discovery process arranged side by side. Then, in a case where a communication apparatus is selected from the list, the CPU 103 executes the processing of S708 onward after communication with the selected communication apparatus has started.

Note that here, the CPU 103 may not display all of the communication apparatuses which are the transmission source of the beacon information received by the information processing apparatus 101.

For example, there are cases where the beacon information stores information relating to a service that can be provided by the communication apparatus which is the transmission source of the beacon information and information relating to the model or vendor of the communication apparatus. In such cases, for example, if the received beacon information includes information indicating that a printing service can be provided, the CPU 103 displays the communication apparatus which is the transmission source of the beacon information in a list. If the received beacon information does not include this information, the communication apparatus is not displayed in the list. Also, for example, if the received beacon information includes information relating to the model or vendor corresponding to the printing application, the CPU 103 displays the communication apparatus which is the transmission source of the beacon information in a list. If the received beacon information does not include this information, the communication apparatus is not displayed in the list.

Also, for example, there are cases where the beacon information stores information relating to the state of the communication apparatus which is the transmission source of the beacon information. In such cases, for example, if the received beacon information does not include information indicating that the communication apparatus is in a busy state or an error state, the CPU 103 displays the communication apparatus which is the transmission source of the beacon information in a list. If the received beacon information does include this information, the communication apparatus is not displayed in the list. This is because if the communication apparatus is in a busy state or an error state, the communication apparatus cannot execute the connection setting processing. Note that the busy state is, for example, a state in which the communication apparatus is executing print or scan processing or a state in which the operation unit of the communication apparatus is being operated.

Also, for example, in a case where the communication apparatus which is the transmission source of the received beacon information is not the communication apparatus registered as the communication destination of the information processing apparatus 101, the communication apparatus which is the transmission source of the beacon information is displayed in the list by the CPU 103. In a case where it is the communication apparatus registered as the communication destination of the information processing apparatus 101, it is not displayed in the list.

Also, for example, there are cases where a communication apparatus in the connection setting mode founded by a known discovery process is transmitting the beacon information. Thus, in a state in which, after the communication apparatus in the connection setting mode is added to the list, the communication apparatus which is the transmission source of the beacon information is added to the list, the same communication apparatus may be displayed twice in the list. Here, the CPU 103 may perform control to ensure the same communication apparatus is not displayed twice in the list. For example, there are cases where the beacon information stores identification information of the communication apparatus which is the transmission source of the beacon information. Also, in a case where a communication apparatus is found via a known discovery process, the CPU 103 can obtain the identification information of the found communication apparatus. Here, in a case where the identification information of the communication apparatus which is the transmission source of the beacon information and the identification information of the communication apparatus found by a known discovery process match, the CPU 103 performs control so that the same communication apparatus is not displayed twice in the list.

The identification of the communication apparatus in S707 can also be implemented by the method described above.

### Second Embodiment

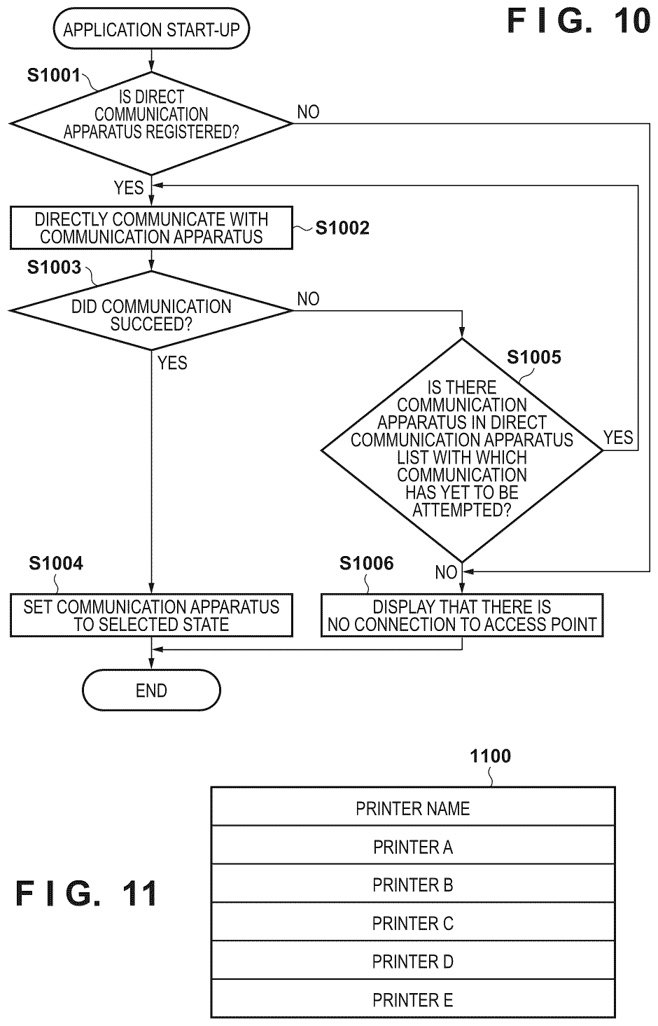

In the first embodiment described above, the flow of FIG. 6 describes a state in which the information processing apparatus 101 is connected to an access point. However, no such limitation is intended. Processing for when the information processing apparatus 101 is not connected to an access point will now be described using FIG. 10. Note that unless otherwise noted, the information processing apparatus 101 and the communication apparatus 151 are as described in the first embodiment. The flowchart of FIG. 10 is implemented by the CPU 103 reading out a program (printing application) stored in the ROM 104 onto the RAM 105 and executing the program.

When the printing application is started up, in S1001, the communication apparatus information control unit 202 references a direct communication apparatus list 1100 illustrated in FIG. 11 and determines whether the direct communication apparatus is registered. Here, the direct communication apparatus list 1100 is where the communication apparatus 151 is registered when the information processing apparatus 101 communicates in the P2P mode for direct communication with the access point inside the communication apparatus 151 without going through the external apparatus forming the network. Note that P2P mode may also include WFD mode for the communication apparatus 151 to communicate via Wi-Fi Direct (WFD). A direct connection established via the communication apparatus 151 operating in P2P mode is referred to as direct communication. The direct communication is the same as the direct connection in the first embodiment. In a case where direct communication is set, the communication apparatus information control unit 202 performs registration of the communication partner communication apparatus on the direct communication apparatus list 1100. Also, when a communication apparatus is set as the target for execution of a command such as printing, the communication apparatus is placed at the top position of the direct communication apparatus list 1100. In other words, the communication apparatuses to be registered in the direct communication apparatus list 1100 are sorted in order of the most recently used. The direct communication setting can be performed by setting the communication apparatus 151 to direct communication mode, starting up the internal access point, and accessing there with a predetermined process.

In a case where the communication apparatus information control unit 202 determines that the direct communication apparatus list 1100 exists in S1001, in S1002, the CPU 103 attempts direct communication with the communication apparatus registered at the top position of the direct communication apparatus list 1100 using the communication unit 111.

In S1003, in a case where communication is successful with the communication apparatus for which direct communication was attempted in S1002, the communication apparatus information control unit 202 sets the communication apparatus to a selected state in S1004. Also, in the direct communication apparatus list, the selected communication apparatus is placed again at the top position.

In a case where communication is unsuccessful with the communication apparatus for which direct communication was attempted in S1002, the communication apparatus information control unit 202 determines whether a communication apparatus for which communication has not been attempted exists in the direct communication apparatus list 1100 in S1005. In a case where a communication apparatus for which communication has not been attempted exists, the communication apparatus information control unit 202 attempts direct communication with the communication apparatus at the position on the direct communication apparatus list 1100 next to the communication apparatus of the most recent attempt for communication in S1002. In a case where no communication apparatus for which communication has not been attempt exists or it is determined that the direct communication apparatus list 1100 does not exist in S1001, in S1006, the display control unit 206 displays a screen (not illustrated) for reporting that the information processing apparatus 101 is not connected to an access point. This notifies the user of this.

According to the embodiment described above, even if the information processing apparatus 101 is not connected to an access point, the communication apparatus to be targeted for execution of a function can be appropriately selected, thus allowing for usability to be improved.

Note that direct communication may be performed using a second communication unit as described in the first embodiment.

### Modified Example of Second Embodiment

FIG. 10 has been described as being executed instead of FIG. 6 of the first embodiment, but it may be combined with FIG. 6. For example, instead of executing FIG. 7A in S610 of FIG. 6, the processing of FIG. 10 may be executed. In this manner, the part where the communication apparatus that can form an infrastructure connection via direct connection is set as a selection candidate in the first embodiment may instead be a communication apparatus that can form a direct connection being set as a selection candidate.

Alternatively, instead of S1006 of FIG. 10, FIG. 7A may be executed. In this manner, first a communication apparatus that can preferentially connect via direct connection can be set as a selection candidate, and then a communication apparatus that can form an infrastructure connection can be set as a selection candidate.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-150283, filed Sep. 15, 2023 which is hereby incorporated by reference herein in its entirety.

What is claimed is:

1. A control method for an information processing apparatus including a predetermined application program, the control method comprising:
obtaining predetermined information for registering a communication apparatus from the communication apparatus;
registering the communication apparatus, which is a transmission source of the predetermined information, to the predetermined application program by associating the communication apparatus with information relating to an access point to which the information processing apparatus was connected when the predetermined information was obtained;
selecting, as a transmission destination of a job, a communication apparatus from among a plurality of the communication apparatuses registered to the predetermined application program; and
transmitting the job to the communication apparatus selected as the transmission destination of the job, wherein
in a case where the information processing apparatus is connecting with a predetermined access point at a predetermined timing for selecting the transmission destination of the job, the communication apparatus associated with the information relating to the predetermined access point and registered to the predetermined application program is automatically selected by the predetermined application program as the transmission destination of the job on a basis of the information processing apparatus being connecting with the predetermined access point at the predetermined timing.

2. The control method according to claim 1, wherein
the predetermined timing is when the predetermined application program is started up.

3. The control method according to claim 1, wherein
in a case where the communication apparatus selected as the transmission destination of the job at the predetermined timing is not associated with the predetermined access point and registered via the predetermined application program, the communication apparatus associated with the information relating to the predetermined access point and registered to the predetermined application program is automatically selected by the predetermined application program as the transmission destination of the job.

4. The control method according to claim 1, wherein
in a case where the communication apparatus selected as the transmission destination of the job at the predetermined timing does not exist, the communication apparatus associated with the information relating to the predetermined access point and registered to the predetermined application program is automatically selected by the predetermined application program as the transmission destination of the job.

5. The control method according to claim 4, wherein
a case where the communication apparatus selected as the transmission destination of the job at the predetermined timing does not exist includes a case where the communication apparatus registered to the predetermined application program does not exist.

6. The control method according to claim 1, wherein
in a case where a plurality of the communication apparatuses associated with the information relating to the predetermined access point and registered to the predetermined application program exist, from among the plurality of communication apparatuses associated with the information relating to the predetermined access point and registered to the predetermined application program, the communication apparatus last used is automatically selected by the predetermined application program as the transmission destination of the job.

7. The control method according to claim 1, wherein
in a case where a plurality of the communication apparatuses associated with the information relating to the predetermined access point and registered to the predetermined application program exist, from among the plurality of communication apparatuses associated with the information relating to the predetermined access point and registered to the predetermined application program and the plurality of communication apparatuses with which the information processing apparatus can communicate, the communication apparatus last used is automatically selected by the predetermined application program as the transmission destination of the job.

8. The control method according to claim 1, further comprising:
executing search processing to search for the communication apparatus on a network of the predetermined access point in a case where the communication apparatus associated with the information relating to the predetermined access point and registered to the predetermined application program is not included in one or more of the communication apparatuses registered to the predetermined application program at the predetermined timing, wherein
the communication apparatus detected via the search processing is associated with the information relating to the predetermined access point and registered to the predetermined application program.

9. The control method according to claim 8, further comprising:
displaying a plurality of the communication apparatuses detected via the search processing in a case where a plurality of the communication apparatuses are detected via the search processing, wherein
the communication apparatus selected by a user from among the plurality of communication apparatuses displayed is associated with the information relating to the predetermined access point and registered to the predetermined application program.

10. The control method according to claim 8, wherein
in a case where a plurality of the communication apparatuses are detected via the search processing, from among a plurality of the communication apparatuses detected via the search processing, a certain one of the communication apparatuses selected on a basis of wave intensity or found order is associated with the information relating to the predetermined access point and registered to the predetermined application program.

11. The control method according to claim 8, further comprising:
establishing a connection between the communication apparatus operating in a predetermined mode for connection setting of the communication apparatus and the information processing apparatus in a case where the communication apparatus is not detected via the search processing; and
transmitting information for connecting a certain access point, to the communication apparatus via the connection.

12. The control method according to claim 11, wherein
information for connecting to the predetermined access point is transmitted to the communication apparatus via the connection.

13. The control method according to claim 11, further comprising:
obtaining information of a list of access points to which the communication apparatus can connect from the communication apparatus via the connection, wherein
in a case where the predetermined access point is included in the list, information for connecting to the predetermined access point is transmitted to the communication apparatus via the connection, and
in a case where the predetermined access point is not included in the list, information for connecting to an access point selected by a user from the list is transmitted to the communication apparatus via the connection.

14. The control method according to claim 11, wherein
after the information for connecting to a certain access point is transmitted to the communication apparatus via the connection, the communication apparatus is registered to the predetermined application program.

15. The control method according to claim 11, further comprising:
re-establishing a connection between the predetermined access point and the information processing apparatus after the information for connecting to a certain access point is transmitted to the communication apparatus via the connection.

16. The control method according to claim 1, further comprising:
attempting to communicate with the communication apparatus operating in a direct communication mode for communicating while not going through an external apparatus forming a network in a case where the information processing apparatus is not connecting with any access point at the predetermined timing, wherein
in a case where communication with the communication apparatus operating in the direct communication mode is successful, the communication apparatus operating in the direct communication mode is selected as the transmission destination of the job.

17. The control method according to claim 1, wherein
the predetermined information is capability information of the communication apparatus.

18. The control method according to claim 1, wherein
the job is a print job or a scan job.

19. An information processing apparatus including a predetermined application program, the information processing apparatus comprising:
obtaining means for obtaining predetermined information for registering a communication apparatus from the communication apparatus;
registering means for registering the communication apparatus, which is a transmission source of the predetermined information, to the predetermined application program by associating the communication apparatus with information relating to an access point to which the information processing apparatus was connected when the predetermined information was obtained;
selecting means for selecting, as a transmission destination of a job, a communication apparatus from among a plurality of the communication apparatuses registered to the predetermined application program; and
transmitting means for transmitting the job to the communication apparatus selected as the transmission destination of the job, wherein
in a case where the information processing apparatus is connecting with a predetermined access point at a predetermined timing for selecting the transmission destination of the job, the communication apparatus associated with the information relating to the predetermined access point and registered to the predetermined application program is automatically selected by the predetermined application program as the transmission destination of the job on a basis of the information processing apparatus being connecting with the predetermined access point at the predetermined timing.

20. A storage medium storing a program which is a predetermined application program that causes a computer of an information processing apparatus to:
obtain predetermined information for registering a communication apparatus from the communication apparatus;
register the communication apparatus, which is a transmission source of the predetermined information, to the predetermined application program by associating the communication apparatus with information relating to an access point to which the information processing apparatus was connected when the predetermined information was obtained;
select, as a transmission destination of a job, a communication apparatus from among a plurality of the communication apparatuses registered to the predetermined application program; and
transmit the job to the communication apparatus selected as the transmission destination of the job, wherein
in a case where the information processing apparatus is connecting with a predetermined access point at a predetermined timing for selecting the transmission destination of the job, the communication apparatus associated with the information relating to the predetermined access point and registered to the predetermined application program is automatically selected by the predetermined application program as the transmission destination of the job on a basis of the information processing apparatus being connecting with the predetermined access point at the predetermined timing.
